(19) United States
(12) Patent Application Publication
(10) Pub. No.: US 2011/0090471 A1
(43) Pub. Date: Apr. 21, 2011

(54) Lens Shift Mechanism and Projection Video Display Apparatus

(75) Inventors: Takeshi FUJISAKI, Amagasaki-shi (JP); Taichi YOSHIMURA, Osaka (JP)

(73) Assignee: SANYO ELECTRIC CO., LTD., Osaka (JP)

(21) Appl. No.: 12/906,016

(22) Filed: Oct. 15, 2010

(30) Foreign Application Priority Data
Oct. 16, 2009 (JP) 2009-239255 P

(51) Int. Cl. G03B 21/14; G02B 7/02

(52) U.S. Cl. 353/101; 359/813

(57) ABSTRACT

A lens shift mechanism includes a projection lens drive unit, a vertical-horizontal limit sensor which detects that a projection lens apparatus reaches a limit in a shift range in vertical and horizontal directions, and a vertically-horizontally central sensor which detects that the projection lens apparatus reaches a central position in the shift range. The vertically-horizontally central sensor has a detection width having a central value at the central position. When a microcomputer automatically returns the projection lens apparatus to the central position within the shift range after a shift operation, the microcomputer shifts the projection lens apparatus in a forward direction directed from a position at a time point when automatic return is started toward the central position, and thereafter shifts the projection lens apparatus again in a backward direction by substantially half the detection width of the vertically-horizontally central sensor.

This nonprovisional application is based on Japanese Patent Application No. 2009-239255 filed on Oct. 16, 2009 with the Japan Patent Office, the entire contents of which are hereby incorporated by reference.

### BACKGROUND OF THE INVENTION

1. Field of the Invention

The present invention relates to a lens shift mechanism and a projection video display apparatus, and more particularly to a lens shift mechanism and a projection video display apparatus having an automatic return function for a projection lens apparatus.

2. Description of the Related Art

Some of projectors as projection video display apparatuses are configured such that a position of a projection lens is shifted within a given range utilizing a motor or the like to adjust a position of a projected image plane thereof. For example, as a shift control method for a projection lens, a sensor sensing arrival of a projection lens or a movable member integrated with the projection lens is arranged in the vicinity of an end portion in a shift range of the projection lens or the movable member, and if the sensor senses arrival of the projection lens or the movable member while the projection lens is being shifted, speed switching means reduces a driving force of a motor to a predetermined value. Such a configuration prevents the projection lens or the movable member from strongly abutting other fixed members and being locked at the end portion in the shift range during a shift operation of the projection lens.

Some of the projectors mounted with a lens shift mechanism described above have a function of automatically returning the projection lens to a central position within the shift range after the shift operation.

To implement such an automatic return function, for example, a sensor for sensing arrival of a projection lens to a central position within a shift range of the projection lens is arranged at the central position. If the sensor senses arrival of the projection lens while the projection lens is being shifted, driving of a motor is stopped, and thereby the projection lens can be returned to the central position.

However, since an optical sensor or the like utilizing transmission/blocking of light is generally used as the sensor for sensing arrival of the projection lens, the sensor has an inherent detection width determined by an optical structure thereof. Accordingly, there is a possibility that a position at which the projection lens is stopped based on a sensing result of the sensor may be deviated from the central position within the shift range, depending on the size of the detection width of the sensor. In addition, a problem may be caused in which the projection lens is stopped at different positions depending on a direction in which the projection lens is shifted. As a result, it is difficult to return the projection lens to the central position accurately.

To avoid such a problem, it is conceivable to configure a hardware circuit capable of precisely detecting the central position by further adding an optical sensor such as a photocoupler in the vicinity of the central position. With such a configuration, however, a light-shielding mechanism corresponding to the added optical sensor and a circuit for processing a detection signal of the optical sensor are newly required, causing a problem that the cost of the apparatus is increased. Further, there is a possibility that arrangement of such a hardware circuit may be limited in terms of the layout of the lens shift mechanism.

### SUMMARY OF THE INVENTION

One object of the present invention is to provide a lens shift mechanism and a projection video display apparatus capable of automatically returning a projection lens apparatus without adding a hardware circuit to a drive mechanism.

A lens shift mechanism in accordance with an aspect of the present invention is a lens shift mechanism which shifts a projection lens apparatus in a reciprocating manner within a given range in a direction of one of two axes perpendicular to an optical axis of the projection lens apparatus, including: a drive mechanism which drives the projection lens apparatus in the direction of one axis; a control unit which controls the drive mechanism to return the projection lens apparatus to a central position within the given range after the projection lens apparatus is shifted; and a central position detection unit which detects that the projection lens apparatus reaches the central position within the given range. The central position detection unit has a detection width having a central value at the central position along the direction of one axis. The control unit includes a first drive unit which causes the drive mechanism to shift the projection lens apparatus in a forward direction directed from a position at a time point when return is started toward the central position, and a second drive unit which causes the drive mechanism to shift the projection lens apparatus again in a backward direction opposite to the forward direction by substantially half the detection width after the projection lens apparatus is shifted by the first drive unit by the detection width.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a projection video display apparatus in accordance with an embodiment of the present invention.

FIG. 2 is an exploded perspective view showing a lens shift mechanism in FIG. 1.

FIG. 3 is an enlarged view of a portion of FIG. 2.

FIG. 4 is a perspective view of sensors SHL, SHC, SHR in FIG. 3.

FIG. 5 is a view showing an example of a detection voltage of sensor SHC (a horizontally central sensor).

FIG. 6 is a view showing another example of the detection voltage of sensor SHC (the horizontally central sensor).

FIG. 7 is a flowchart illustrating automatic return processing for a projection lens apparatus in accordance with the present embodiment.

FIG. 8A, 8B, 8C are views illustrating detection of a position of the projection lens apparatus.

### DESCRIPTION OF THE PREFERRED EMBODIMENTS

Hereinafter, an embodiment of the present invention will be described in detail with reference to the drawings, in which identical or corresponding parts will be designated by the same reference numerals, and the description thereof will not be repeated.

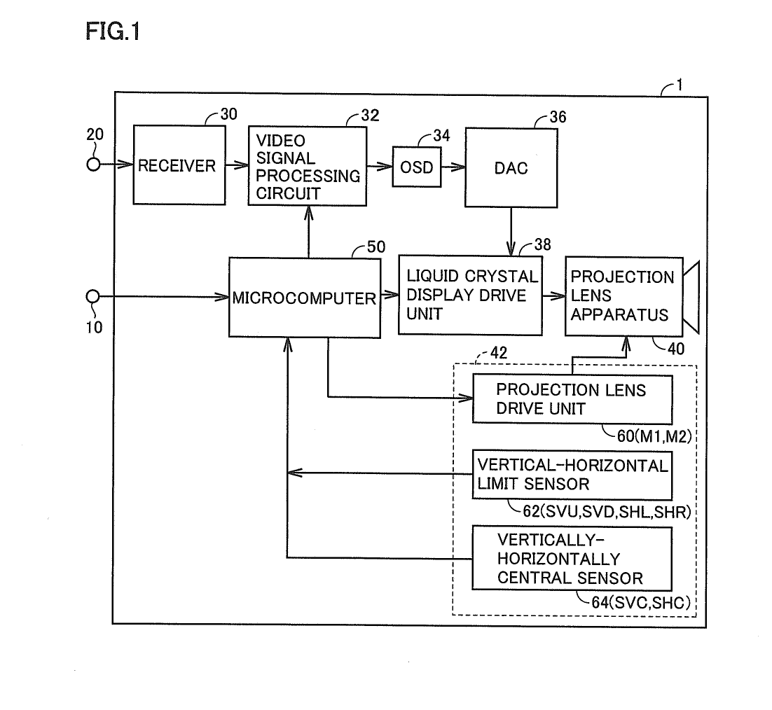

FIG. 1 is a view illustrating a projection video display apparatus in accordance with an embodiment of the present invention.

Referring to FIG. 1, a projection video display apparatus (hereinafter also referred to as a “projector”) 1 in accordance with the present embodiment is a liquid crystal projector projecting a video utilizing a liquid crystal device, which projects (displays) the video by projecting light of the video displayed by the liquid crystal device on a screen. A projection surface is not limited to the screen, and may be a wall surface.

Projector 1 includes a remote controller reception unit 10 receiving an infrared modulated remote controller signal transmitted from a remote controller manipulated by a user, and an input unit 20. The remote controller signal includes a command signal for remotely controlling projector 1. Input unit 20 includes an input port for receiving a video signal supplied from an external signal supply apparatus (not shown). The signal supply apparatus includes a digital signal supply apparatus outputting a digital signal such as a DVD (Digital Versatile Disc) reproduction apparatus and a Blu-Ray disc reproduction apparatus, and an analog signal supply apparatus outputting an analog signal such as a computer.

Projector 1 further includes a receiver 30, a video signal processing circuit 32, an OSD (On Screen Display) circuit 34, a DAC (Digital Analog Converter) 36, a microcomputer 50, a liquid crystal display drive unit 38, a projection lens apparatus 40, and a lens shift mechanism 42.

Microcomputer 50 generates a control command and outputs it to each unit of projector 1, based on the command signal received from the remote controller (not shown) via remote controller reception unit 10.

Receiver 30 receives and outputs the video signal supplied from input unit 2. Receiver 30 has a function as an ADC (Analog Digital Converter) converting the received analog video signal into a digital signal, and an authentication function and a decryption function in compliance with the HDCP (High-Bandwidth Digital Content Protection) system. It is to be noted that HDCP is used to implement encryption of data transmitted in compliance with HDMI (High Definition Multimedia Interface). This can prevent illegal copying of a content such as a video signal transmitted over a digital transmission path. Although it is described here that the digital transmission path is a path transmitting data and signals in compliance with HDMI, it may be a transmission path in compliance with DVI (Digital Visual Interface).

Video signal processing circuit 32 processes the video signal output from receiver 30 into a signal for display, and outputs the signal. Specifically, video signal processing circuit 32 writes the video signal from receiver 30 in a frame memory (not shown) for each frame (each image plane), and reads a video stored in the frame memory. Then, by performing various video processing during the writing and reading processing, video signal processing circuit 32 converts the input video signal and generates video data as a video signal for a projection video.

OSD circuit 34 superimposes a signal of image data based on information supplied from microcomputer 50 on the video signal output from video signal processing circuit 32, and outputs the video signal after superimposition.

DAC 36 receives the video signal output from OSD circuit 34, converts it into an analog signal, and outputs the analog signal to liquid crystal display drive unit 38.

Liquid crystal display drive unit 38, projection lens apparatus 40, and a lamp (not shown) are equivalent to a “display unit” for displaying a video on the screen in accordance with the video signal output from DAC 36 under the control of microcomputer 50.

An operation of the display unit will be described. The lamp (not shown) as an illumination apparatus includes, for example, an extra high pressure mercury lamp, a metal halide lamp, and a xenon lamp. The lamp is removably attached to projector 1 via a connector. Substantially parallel light is emitted from the lamp to liquid crystal display drive unit 38.

Liquid crystal display drive unit 38 includes an optical system including a lens and a prism not shown, and R, G, and B liquid crystal panels. In liquid crystal display drive unit 38, the light from the lamp passing through an inside lens system not shown enters the R, G, and B liquid crystal panels such that uniform light amount distribution is obtained. Of the light entering through the lens system, light in a blue wavelength band (hereinafter referred to as “B light”), light in a red wavelength band (hereinafter referred to as “R light”), and light in a green wavelength band (hereinafter referred to as “G light”) enter the R, G, and B liquid crystal panels, respectively, as substantially parallel light. The liquid crystal panels are driven in accordance with video signals corresponding to R, G, and B supplied from DAC 36, and modulate the light in accordance of a drive state thereof. The R light, G light, and B light modulated by the liquid crystal panels are color-synthesized by a dichroic prism, and thereafter projected on the screen in an enlarged manner by projection lens apparatus 40.

Projection lens apparatus 40 includes a lens group for forming an image of the projected light on the screen, and an actuator for adjusting a zoom state and a focus state of the projection video by changing a portion of the lens group in an optical axis direction.

Projection lens apparatus 40 is configured to be shiftable in a given range from the center of an optical axis of the liquid crystal panel and the dichroic prism such that a position of an image plane projected onto the screen can be adjusted in a vertical direction and a horizontal direction. The shift range for projection lens apparatus 40 is determined in each of the vertical direction and the horizontal direction. Further, a shift operation of projection lens apparatus 40 can be performed by lens shift mechanism 42.

Lens shift mechanism 42 shifts a position of projection lens apparatus 40 within a given range to adjust the position of the projected image plane. Lens shift mechanism 42 includes a projection lens drive unit 60, a vertical-horizontal limit sensor 62, and a vertically-horizontally central sensor 64.

Projection lens drive unit 60 is configured by combining a motive power drive source such as a motor with a motive power transmission mechanism such as a gear mechanism. The motive power transmission mechanism converts a rotary force of the motor into a linear shifting force in the vertical direction or in the horizontal direction, and thereby projection lens apparatus 40 can be shifted in the vertical direction or in the horizontal direction. The number of rotations of the motor is controlled by microcomputer 50.

Vertical-horizontal limit sensor 62 and vertically-horizontally central sensor 64 are arranged at predetermined positions in the shift range of projection lens apparatus 40 to detect a positional state of projection lens apparatus 40.

Specifically, vertical-horizontal limit sensor 62 includes a vertical limit sensor for detecting that projection lens apparatus 40 reaches an upper limit or a lower limit in the shift range in the vertical direction, and a horizontal limit sensor for detecting that projection lens apparatus 40 reaches a left limit or a right limit in the shift range in the horizontal direction.

In addition, vertically-horizontally central sensor 64 includes a vertically central sensor for detecting that projection lens apparatus 40 reaches a central position in the shift range in the vertical direction, and a horizontally central sensor for detecting that projection lens apparatus 40 reaches a central position in the shift range in the horizontal direction.

Various sensors can be utilized as vertical-horizontal limit sensor 62 and vertically-horizontally central sensor 64, and for example an optical sensor such as a PI (photointerrupter) sensor using transmission/blocking of light can be utilized. Detection signals of vertical-horizontal limit sensor 62 and vertically-horizontally central sensor 64 are output to microcomputer 50.

The shift operation of projection lens apparatus 40 can be manipulated with a switch provided to a main body of projector 1 or the remote controller. When the switch provided for example to the remote controller is turned on, the motor is driven to shift projection lens apparatus 40 in the shift range, and when the switch is turned off, the motor is stopped to stop shifting projection lens apparatus 40.

Based on the detection signals of vertical-horizontal limit sensor 62 and vertically-horizontally central sensor 64, microcomputer 50 drives and controls the motor to shift projection lens apparatus 40 within the shift range in the vertical direction or in the horizontal direction in a reciprocating manner.

Further, microcomputer 50 monitors the positional state of projection lens apparatus 40 during the shift operation of projection lens apparatus 40 described above, and when a reset switch provided to the main body of projector 1 or the remote controller is turned on after the shift operation, microcomputer 50 automatically returns projection lens apparatus 40 to the central position in the shift range by a method described later.

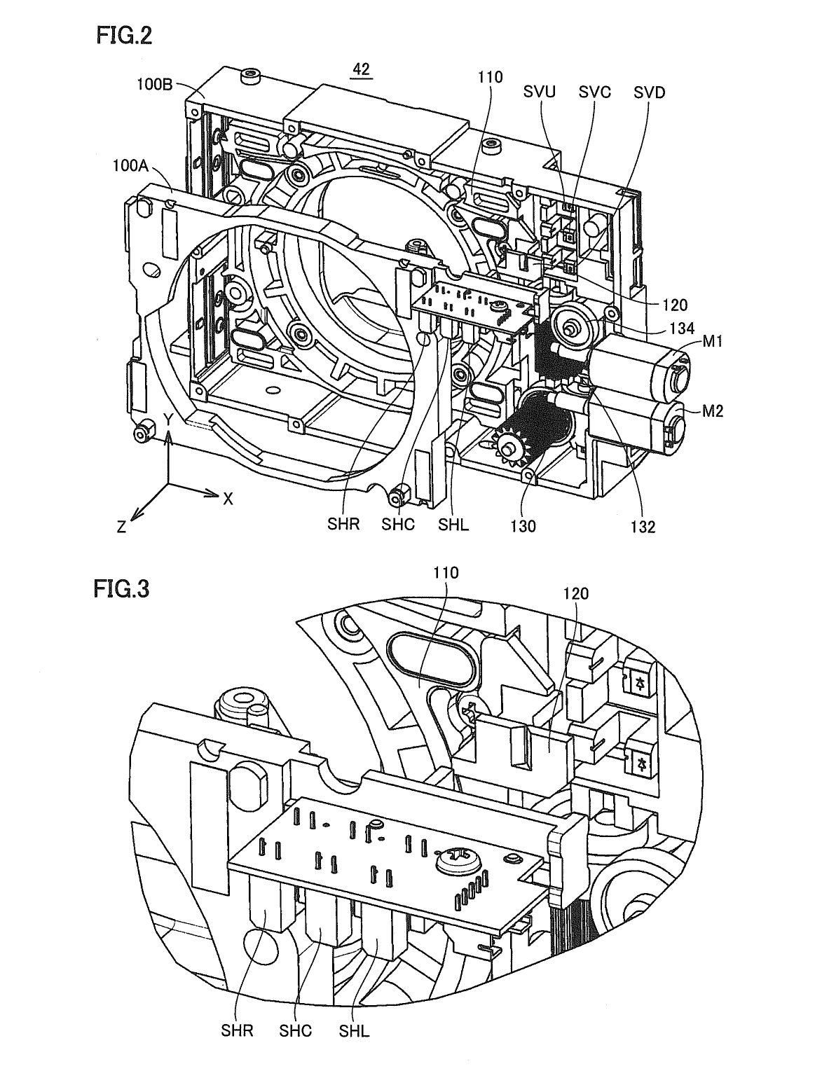

FIG. 2 is an exploded perspective view showing lens shift mechanism 42 in FIG. 1. In the description below, a direction toward the front of a paper plane of FIG. 2 (a z direction) will be referred to as a direction in which projector 1 projects a video, and the left side and the right side are defined toward the direction in which the video is projected.

Referring to FIG. 2, projection lens apparatus 40 (not shown) is attached to a projection lens attachment plate (not shown) provided to liquid crystal display drive unit 38, via fixed members 100A, 100B. Specifically, to the projection lens attachment plate of liquid crystal display drive unit 38, fixed members 100A, 100B constituting lens shift mechanism 42 are attached, and a movable member 110 that is shiftable in the vertical direction and the horizontal direction with respect to fixed members 100A, 100B is attached. Then, projection lens apparatus 40 (not shown) is attached to movable member 110, and movable member 110 and projection lens apparatus 40 are integrated.

Motors M1, M2 as drive sources for shifting movable member 110 including projection lens apparatus 40 are attached to fixed member 100B. Rotation of motors M1, M2 is transmitted to a rotation axis (not shown) via gears 130, 132, 134. Rotation of the rotation axis is transmitted to a slide member (not shown) engaging the rotation axis and sliding in accordance with the rotation. The slide member is coupled and fixed to a portion of movable member 110, and movable member 110 is shifted in the vertical direction (a y direction) and the horizontal direction (an x direction) in accordance with sliding of the slide member.

It is to be noted that the motive power transmission mechanism including gears 130, 132, 134, the rotation axis, the slide member, and the like shown in FIG. 2 is an example, and motive power transmission mechanisms in other various forms can be used.

Further, sensors SHL, SHC, SEM for detecting the positional state of projection lens apparatus 40 in the horizontal direction are arranged in fixed member 100A. In addition, sensors SVU, SVC, SVD for detecting the positional state of projection lens apparatus 40 in the vertical direction are arranged in fixed member 100B.

FIG. 3 is an enlarged view of a portion of FIG. 2 (sensors SHL, SHC, SHR and a light-shielding plate 120).

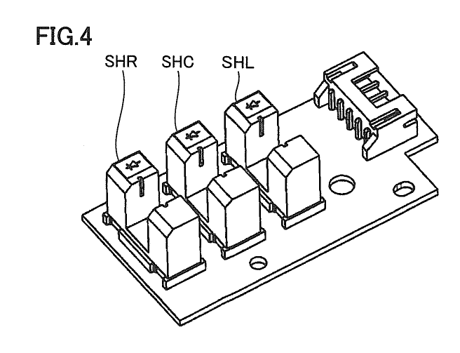

Referring to FIG. 3, three sensors SHL, SHC, SHR are arranged at a regular interval in the horizontal direction. FIG. 4 shows a perspective view of sensors SHL, SHC, SHR.

Referring to FIGS. 3 and 4, each of sensors SHL, SHC, SHR is an optical sensor (for example, a PI sensor), and has a light emitting unit and a light receiving unit. The light emitting unit includes a light emitting element such as a light emitting diode, a light emitting FET (Field Effect Transistor), and an EL (electroluminescence) element. The light receiving unit includes a light receiving element receiving light from the light emitting unit. As the light receiving element, various light receiving elements such as a photodiode, a phototransistor, an avalanche photodiode, and a pyroelectric infrared element can be used.

As shown in FIG. 3, light-shielding plate 120 extending in the horizontal direction is arranged in movable member 110. Specifically, light-shielding plate 120 is shifted in the horizontal direction with respect to fixed members 100A and 100B, together with movable member 110. A gap portion having a predetermined width is provided to light-shielding plate 120 at a central portion in the horizontal direction.

Further, light-shielding plate 120 is arranged to use a space between the light emitting units and the light receiving units of sensors SHL, SHC, SHR as a shift path, in a state where fixed member 100A and fixed member 100B are assembled. Thereby, in each of sensors SHL, SHC, SHR, the light emitted from the light emitting unit toward the light receiving unit is temporarily blocked in accordance with a shift operation of light-shielding plate 120. Sensors SHL, SHC, SHR detect the positional state of projection lens apparatus 40 based on transmission/blocking of the light by light-shielding plate 120.

Specifically, when movable member 110 including projection lens apparatus 40 is shifted in the right direction, sensor SHR detects passage of a right end portion of light-shielding plate 120, and thereby it can be known that projection lens apparatus 40 reaches the right limit in the shift range based on a detection result thereof. In addition, when movable member 110 is shifted in the left direction, sensor SHL detects passage of a left end portion of light-shielding plate 120, and thereby it can be known that projection lens apparatus 40 reaches the left limit in the shift range based on a detection result thereof. Namely, sensors SHR and SHL constitute “horizontal limit sensors” of vertical-horizontal limit sensor 62 (FIG. 1).

On the other hand, when movable member 110 is shifted in the right direction or in the left direction, sensor SHC detects passage of a central portion of light-shielding plate 120, and thereby it can be known that projection lens apparatus 40 reaches the central position in the shift range based on a detection result thereof. Namely, sensor SHC constitutes a “horizontally central sensor” of vertically-horizontally central sensor 64 (FIG. 1).

In FIG. 2, three sensors SVU, SVC, SVD are further arranged at a regular interval in the vertical direction. Each of sensors SVU, SVC, SVD includes an optical sensor (for example, a PI sensor) as with sensors SHL, SHC, SHR, and has a light emitting unit and a light receiving unit. Further, although not shown, a light-shielding plate extending in the vertical direction is arranged in movable member 110, and the light-shielding plate is shifted in the vertical direction with respect to fixed members 100A and 100B, together with movable member 110. A gap portion having a predetermined width is provided to the light-shielding plate at a central portion in the vertical direction.

The light-shielding plate is arranged to use a space between the light emitting units and the light receiving units of sensors SVU, SVC, SVD as a shift path, in a state where fixed member 100A and fixed member 100B are assembled. Thereby, in each of sensors SVU, SVC, SVD, light emitted from the light emitting unit toward the light receiving unit is temporarily blocked in accordance with a shift operation of the light-shielding plate. Sensors SVU, SVC, SVD detect the positional state of projection lens apparatus 40 based on transmission/blocking of the light by the light-shielding plate.

Specifically, when movable member 110 including projection lens apparatus 40 is shifted in an upward direction, sensor SVU detects passage of an upper end portion of the light-shielding plate, and thereby it can be known that projection lens apparatus 40 reaches the upper limit in the shift range based on a detection result thereof. In addition, when movable member 110 is shifted in a downward direction, sensor SVD detects passage of a lower end portion of the light-shielding plate, and thereby it can be known that projection lens apparatus 40 reaches the lower limit in the shift range based on a detection result thereof. Namely, sensors SVU and SVD constitute “vertical limit sensors” of vertical-horizontal limit sensor 62 (FIG. 1).

On the other hand, when movable member 110 is shifted in the upward direction or in the downward direction, sensor SVC detects passage of a central portion of the light-shielding plate, and thereby it can be known that projection lens apparatus 40 reaches the central position in the shift range based on a detection result thereof. Namely, sensor SVC constitutes a “vertically central sensor” of vertically-horizontally central sensor 64 (FIG. 1).

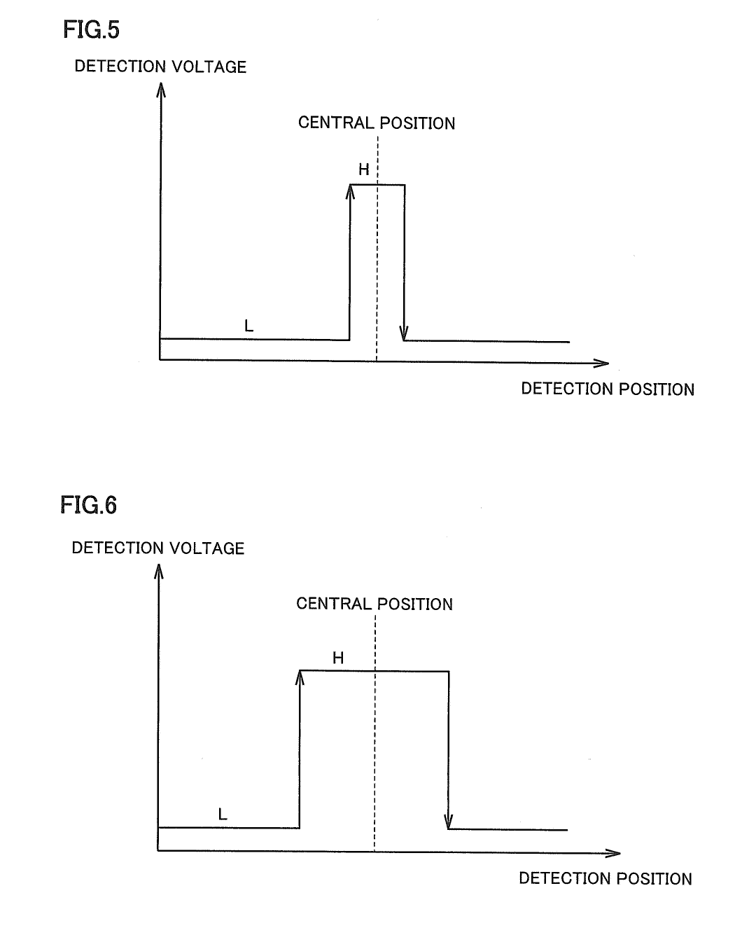

FIG. 5 is a view showing a detection voltage of sensor SHC (the horizontally central sensor).

Referring to FIG. 5, sensor SHC as the horizontally central sensor outputs a detection voltage at an L (logical low) level in a period in which the light from the light emitting unit to the light receiving unit is blocked and not received, and outputs a detection voltage at an H (logical high) level in a period in which the light from the light emitting unit to the light receiving unit is received.

In the present embodiment, when movable member 110 is shifted in the right direction or in the left direction, the gap portion of light-shielding plate 120 passes through the space between the light emitting unit and the light receiving unit of sensor SHC, and thereby the light from the light emitting unit temporarily passes through light-shielding plate 120 and is received by the light receiving unit. On this occasion, the detection voltage of sensor SHC rises from an L level to an H level at timing when the light receiving unit receives the light from the light emitting unit, and falls from an H level to an L level at timing when the light from the light emitting unit is blocked again by light-shielding plate 120. As a result, as shown in FIG. 5, the detection voltage has a detection width having a central value at the central position in the shift range. The detection width has a value depending on the width of the gap portion provided to light-shielding plate 120.

As described above, projector 1 has a function of automatically returning projection lens apparatus 40 to the central position in the shift range when the reset switch provided to the main body of projector 1 or the remote controller is turned on after the shift operation. For processing for automatic return, it is possible to employ a configuration in which, for example, in order to return projection lens apparatus 40 to the central position in the shift range in the horizontal direction, projection lens apparatus 40 is shifted in the left direction or in the right direction from its position after the shift operation toward the central position, the detection voltage of sensor SHC as the horizontally central sensor on that occasion is monitored, and shift of projection lens apparatus 40 is stopped at timing when the detection voltage rises from an L level to an H level.

However, since the detection width of sensor SHC as the horizontally central sensor depends on the width of the gap portion provided to light-shielding plate 120, a problem may be caused in which the shift of projection lens apparatus 40 is stopped at a position deviated from the central position, depending on a structure of the gap portion. Further, a problem may be caused in which projection lens apparatus 40 is stopped at different positions depending on a direction in which projection lens apparatus 40 is shifted.

Specifically, as the width of the gap portion of light-shielding plate 120 increases, the detection width of horizontally central sensor SHC increases, as shown in FIG. 6. Here, assume a case where projection lens apparatus 40 is returned to the central position in the shift range in the horizontal direction by the configuration described above. Namely, it is assumed that, when projection lens apparatus 40 is shifted in the left direction or in the right direction from its position after the shift operation toward the central position, the shift of projection lens apparatus 40 is stopped at the timing when the detection voltage of horizontally central sensor SHC rises from an L level to an H level.

In this case, due to the wide detection width of horizontally central sensor SHC, the position at which projection lens apparatus 40 is stopped is considerably deviated from the central position in the shift range. Therefore, a deviation equivalent to the detection width occurs between a position at which projection lens apparatus 40 is stopped when projection lens apparatus 40 is shifted in the left direction toward the central position and a position at which projection lens apparatus 40 is stopped when projection lens apparatus 40 is shifted in the right direction toward the central position. As a result, it is difficult to return projection lens apparatus 40 to the central position accurately.

To avoid such a problem, it is conceivable to configure a hardware circuit capable of precisely detecting the central position by further adding an optical sensor such as a photocoupler in the vicinity of the central position. With such a configuration, however, a mechanism for blocking light from a light emitting unit to a light receiving unit in the added optical sensor and a circuit for processing a detection signal of the optical sensor are newly required, causing a problem that the cost of the apparatus is increased. Further, there is a possibility that arrangement of such a hardware circuit may be limited in terms of the layout of the lens shift mechanism.

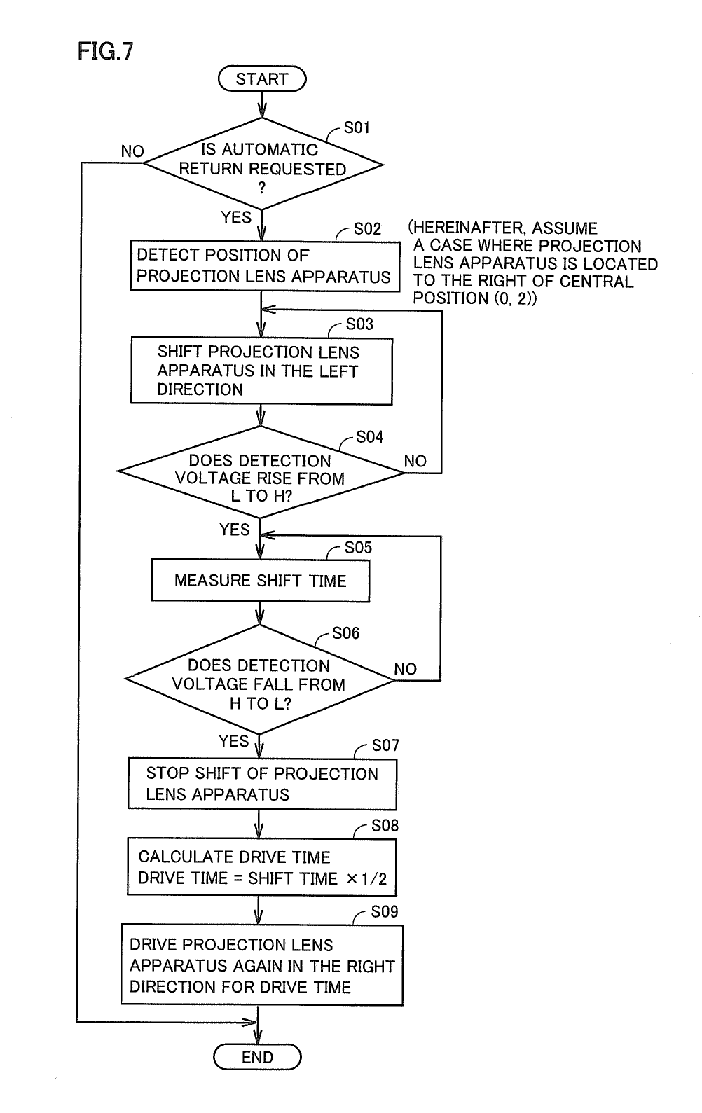

Accordingly, in projector 1 in accordance with the present embodiment, in order to automatically return projection lens apparatus 40 to the central position in the shift range without adding a hardware, circuit projection lens apparatus 40 is shifted in a reciprocating manner in accordance with a processing procedure shown in FIG. 7.

FIG. 7 is a flowchart illustrating automatic return processing for projection lens apparatus 40 in accordance with the present embodiment. The flowchart shown in FIG. 7 can be implemented by microcomputer 50 executing a program stored beforehand.

Referring to FIG. 7, in order to perform the automatic return processing for projection lens apparatus 40, it is firstly determined whether or not automatic return of projection lens apparatus 40 is requested after the shift operation of projection lens apparatus 40 (step S01). Specifically, it is determined whether or not the reset switch provided to the main body of projector 1 or the remote controller is turned on. If it is determined that the automatic return of projection lens apparatus 40 is not requested (NO in step S01), the processing is terminated.

On the other hand, if it is determined that the automatic return of projection lens apparatus 40 is requested based on turning on of the reset switch (YES in step S01), a position of projection lens apparatus 40 at timing when the automatic return is started is detected (step S02).

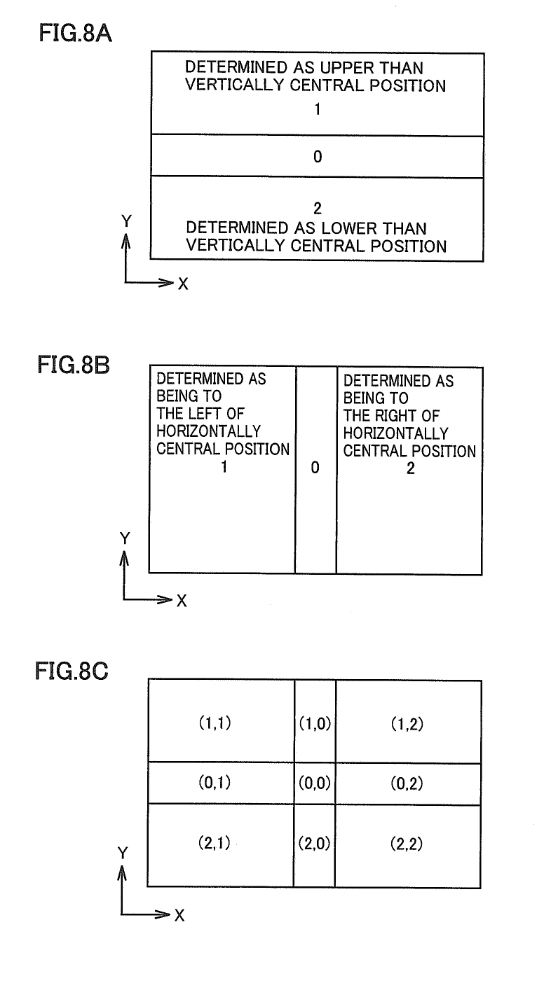

Specifically, microcomputer 50 detects the position of projection lens apparatus 40 based on a history of manipulation of the switch provided to the main body of projector 1 or the remote controller during execution of the shift operation. FIG. 8A, 8B, 8C show views illustrating detection of the position of projection lens apparatus 40 in step S02. Referring to FIG. 8A, the position of projection lens apparatus 40 in the vertical direction is divided into three regions, that is, a region in the vicinity of the central position in the shift range, a region upper than the vicinity of the central position, and a region lower than the vicinity of the central position. Microcomputer 50 indicates in which of the three regions projection lens apparatus 40 is located, using numbers “1”, “0”, “2”, based on a manipulation amount and a manipulation direction of the switch. In an example shown in FIG. 8A, the region upper than the vicinity of the central position in the shift range in the vertical direction is indicated as “1”, the region in the vicinity of the central position is indicated as “0”, and the region lower than the vicinity of the central position is indicated as “2”. The number is updated in accordance with the manipulation of the switch.

Similarly, referring to FIG. 8B, the position of projection lens apparatus 40 in the horizontal direction is divided into three regions, that is, a region in the vicinity of the central position in the shift range, a region to the left of the vicinity of the central position, and a region to the right of the vicinity of the central position. Microcomputer 50 indicates in which of the three regions projection lens apparatus 40 is located, using numbers “1”, “0”, “2”, based on a manipulation amount and a manipulation direction of the switch. In an example shown in FIG. 8B, the region to the left of the vicinity of the central position in the shift range in the horizontal direction is indicated as “1”, the region in the vicinity of the central position is indicated as “0”, and the region to the right of the vicinity of the central position is indicated as “2”. The number is updated in accordance with the manipulation of the switch.

By combining FIGS. 8A and 8B, the position of projection lens apparatus 40 within the shift range can be indicated by coordinates including a position in the x direction (horizontal direction) and a position in the y direction (vertical direction) as shown in FIG. 8C. For example, if it is assumed that the central position in the shift range in the vertical and horizontal directions is represented with coordinates (0, 0), the region to the left of the central position can be represented with coordinates (0, 1), and the region to the right of the central position can be represented with coordinates (0, 2). Further, the region upper than the central position and to the left of the central position can be represented with coordinates (1, 1).

Microcomputer 50 updates the coordinates of projection lens apparatus 40 by monitoring the manipulation amount and the manipulation direction of the switch during the execution of the shift operation, using the central position (0, 0) in FIG. 8C as an initial value. Then, microcomputer 50 detects the position of projection lens apparatus 40 at timing when the automatic return is started, based on the coordinates at the timing.

Referring to FIG. 7 again, assume a case where the position of projection lens apparatus 40 detected in step S02 is to the right of the central position (corresponds to the coordinates (0, 2)). In this case, the automatic return of projection lens apparatus 40 is performed in accordance with procedures in steps S03 to S09.

Specifically, in step S03, microcomputer 50 causes projection lens drive unit 60 to shift projection lens apparatus 40 in a direction toward the central position (that is, in the left direction) at a constant speed. On this occasion, microcomputer 50 monitors a detection signal (detection voltage) from horizontally central sensor SHC, and determines whether or not the detection voltage rises from an L level to an H level (step S04). If the detection voltage of the horizontally central sensor does not rise from an L level to an H level (NO in step S04), the processing returns to step S03.

On the other hand, if it is determined that the detection voltage of horizontally central sensor SHC rises from an L level to an H level (YES in step S04), microcomputer 50 measures time required for projection lens apparatus 40 to be shifted by the detection width of horizontally central sensor SHC (FIG. 6) (shift time) by activating a built-in counter at timing when the detection voltage rises to an H level (step S05).

Next, it is determined whether or not the detection voltage of horizontally central sensor SHC falls from an H level to an L level (step S06). If the detection voltage does not fall from an H level to an L level (NO in step S06), the processing returns to step S05.

On the other hand, if it is determined that the detection voltage of horizontally central sensor SHC falls from an H level to an L level (YES in step S06), microcomputer 50 causes projection lens drive unit 60 to stop shifting projection lens apparatus 40 (step S07). Thereby, the shift of projection lens apparatus 40 is stopped when projection lens apparatus 40 reaches a left end portion of the detection width of horizontally central sensor SHC. Further, microcomputer 50 terminates measurement of the shift time by stopping the counter.

Subsequently, drive time for projection lens apparatus 40 is calculated based on the shift time measured in step S05 (step S08). The drive time is equivalent to time taken when projection lens apparatus 40 is driven again in a direction from the left end portion of the detection width of horizontally central sensor SHC toward the central position (that is, in the right direction). The drive time is calculated as time substantially half the shift time.

Finally, microcomputer 50 causes projection lens apparatus 40 to be driven again in the right direction for the drive time (equivalent to substantially half the shift time) calculated in step S08 (step S09). Thereby, projection lens apparatus 40 is shifted from the left end portion of the detection width of horizontally central sensor SHC to approach the central position.

As described above, the automatic return processing for projection lens apparatus 40 shown in FIG. 7 returns projection lens apparatus 40 to the central position in the shift range in the horizontal direction by measuring time required for projection lens apparatus 40 to be shifted by the detection width of horizontally central sensor SHC when projection lens apparatus 40 is shifted in the left direction (shift time), and causing projection lens apparatus 40 to be driven again in an opposite direction (in the right direction) for drive time substantially half the measured shift time. The processing can automatically return projection lens apparatus 40 to the central position without newly adding a hardware circuit capable of precisely detecting the central position.

Although the processing flow in FIG. 7 employs a configuration in which time required for projection lens apparatus 40 to be shifted by the detection width of horizontally central sensor SHC is measured, and then drive time is calculated from the measured shift time, a configuration in which microcomputer 50 measures the number of outputs of a control pulse (for example, a PWM (Pulse Width Modulation) signal) output to motors M1, M2 (FIG. 2) included in projection lens drive unit 60, instead of measuring the shift time, may be employed.

In this case, microcomputer 50 measures the number of outputs of the control pulse required for projection lens apparatus 40 to be shifted by the detection width of horizontally central sensor SHC, and calculates the number equivalent to substantially half the measured number of outputs as the number of drivings. Then, microcomputer 50 causes projection lens drive unit 60 to drive projection lens apparatus 40 again in accordance with the control pulse in the calculated number of drivings.

Although FIG. 7 illustrates the processing procedure for returning projection lens apparatus 40 to the central position in the shift range in the horizontal direction as the automatic return processing for projection lens apparatus 40, projection lens apparatus 40 can be returned to the central position in the shift range in the vertical direction through a similar processing procedure. For example, if projection lens apparatus 40 is located upper than the central position at the timing when the automatic return is started, the automatic return processing can return projection lens apparatus 40 to the central position in the shift range in the vertical direction by measuring time required for projection lens apparatus 40 to be shifted by a detection width of vertically central sensor SVC when projection lens apparatus 40 is shifted in the downward direction, and causing projection lens apparatus 40 to be driven again in an opposite direction (in the upward direction) for drive time substantially half the measured shift time.

Further, if projection lens apparatus 40 is located upper than the central position and to the left of the central position at the timing when the automatic return is started, projection lens apparatus 40 can be returned to the central position in the shift range by performing the automatic return processing in the horizontal direction and the automatic return processing in the vertical direction described above in combination.

In addition, although a liquid crystal projector is employed as the projector in the present embodiment, the present invention is not limited thereto. For example, the technique of the present invention may be employed to projectors of other schemes such as a DLP (Digital Light Processing) (registered trademark) projector.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A lens shift mechanism which shifts a projection lens apparatus in a reciprocating manner within a given range in a direction of one of two axes perpendicular to an optical axis of said projection lens apparatus, comprising:
a drive mechanism which drives said projection lens apparatus in said direction of one axis;
a control unit which controls said drive mechanism to return said projection lens apparatus to a central position within said given range after said projection lens apparatus is shifted; and
a central position detection unit which detects that said projection lens apparatus reaches the central position within said given range,
wherein said central position detection unit has a detection width having a central value at said central position along said direction of one axis, and
said control unit includes
a first drive unit which causes said drive mechanism to shift said projection lens apparatus in a forward direction directed from a position at a time point when return is started toward said central position, and
a second drive unit which causes said drive mechanism to shift said projection lens apparatus again in a backward direction opposite to the forward direction by substantially half said detection width after said projection lens apparatus is shifted by said first drive unit by said detection width.

2. The lens shift mechanism according to claim 1, wherein
said control unit further includes a measurement unit which measures shift time required for said projection lens apparatus to be shifted by said first drive unit by said detection width based on a detection value of said central position detection unit, and
said second drive unit causes said drive mechanism to shift said projection lens apparatus again in the backward direction by substantially half said detection width in accordance with said shift time measured by said measurement unit.

3. The lens shift mechanism according to claim 1, wherein
said drive mechanism includes
a motor which rotates in accordance with a control pulse output from said control unit, and
a motive power transmission mechanism which converts a rotary force of said motor into a linear shifting force and shifts said projection lens apparatus in said direction of one axis,
said control unit further includes a measurement unit which measures a number of outputs of the control pulse required for said projection lens apparatus to be shifted by said first drive unit by said detection width based on a detection value of said central position detection unit, and
said second drive unit causes said drive mechanism to shift said projection lens apparatus again in the backward direction using a number of drivings equivalent to substantially half the number of outputs of said control pulse measured by said measurement unit.

4. A projection video display apparatus, comprising:
a projection lens apparatus; and
a lens shift mechanism which shifts said projection lens apparatus in a reciprocating manner within a given range in a direction of one of two axes perpendicular to an optical axis of said projection lens apparatus,
said lens shift mechanism including
a drive mechanism which drives said projection lens apparatus in said direction of one axis,
a control unit which controls said drive mechanism to return said projection lens apparatus to a central position within said given range after said projection lens apparatus is shifted, and
a central position detection unit which detects that said projection lens apparatus reaches said central position,
wherein said central position detection unit has a detection width having a central value at said central position along said direction of one axis, and
said control unit includes
a first drive unit which causes said drive mechanism to shift said projection lens apparatus in a forward direction directed from a position at a time point when return is started toward said central position, and
a second drive unit which causes said drive mechanism to shift said projection lens apparatus again in a backward direction opposite to the forward direction by substantially half said detection width after said projection lens apparatus is shifted by said first drive unit by said detection width.
